(19) United States
(12) Patent Application Publication
(10) Pub. No.: US 2007/0057755 A1
(43) Pub. Date: Mar. 15, 2007

(54) Solid electrolytic capacitor and manufacturing method thereof

(76) Inventors: Yukiharu Suzuki, Tokyo (JP); Toshihiko Kobayashi, Tokyo (JP); Toshimi Mizoguchi, Tokyo (JP)

Correspondence Address: SNELL & WILMER LLP, 600 ANTON BOULEVARD, SUITE 1400, COSTA MESA, CA, 92626, US

(21) Appl. No.: 10/573,616

(22) PCT Filed: Sep. 29, 2003
(86) PCT No.: PCT/JP03/12430

§ 371 Date: Sep. 18, 2006

(51) Int. Cl. H01F 5/00

(52) U.S. Cl. 336/200

(57) ABSTRACT

The multi-layer transformer 10 of the present invention comprises a composite sheet 14a comprising a center magnetic pattern 11a and peripheral magnetic pattern 12a that are formed at the center and periphery respectively, and a dielectric pattern 13a of a nonmagnetic body that is formed in a part except the center and periphery; a composite sheet 14b similarly comprising a center magnetic pattern 11b, peripheral magnetic pattern 12b and a dielectric pattern 13b; a primary winding 15a that is located on one face of the dielectric pattern 13a; a secondary winding 15b that is located on one face of the dielectric pattern 13b; and magnetic sheets 16a and 16b that hold the composite sheets 14a and 14b, primary winding 15a and secondary winding 15b from both sides and contact one another via the center magnetic patterns 11a and 11b and peripheral magnetic patterns 12a and 12b.

### TECHNICAL FIELD

The present invention relates to a multi-layer magnetic part on which a coil and core are formed by stacking sheets having electromagnetic characteristics and fabrication method thereof.

### BACKGROUND ART

In recent years, multi-layer transformers have attracted attention as multi-layer magnetic parts that are thin, small, and lightweight in accordance with rapid advances in the miniaturization of electronic devices. FIG. 6 is a disassembled perspective view of a stacked body of a conventional multi-layer transformer. FIG. 7 is a vertical cross-sectional view along the line VII-VII in FIG. 6 after stacking. The description below is based on FIGS. 6 and 7.

A conventional multi-layer transformer 80 comprises primary-winding magnetic sheets 82b and 82d on which primary windings 81a and 81c are formed, secondary-winding magnetic sheets 82c and 82e on which secondary windings 81b and 81d are formed, and magnetic sheets 82a and 82g that hold the magnetic sheets 82b to 82e from both sides.

Furthermore, a magnetic sheet 82f for improving the magnetic saturation characteristic is inserted between the magnetic sheet 82e and magnetic sheet 82g. The magnetic sheets 82a to 82e are provided with through-holes 90, 91, and 92 that connect the primary windings 81a and 81c and through-holes 93, 94, and 95 that connect the secondary windings 81b and 81d. The lower face of the magnetic sheet 82a is provided with primary-winding external electrodes 96 and 97 and secondary-winding external electrodes 98 and 99. The through-holes 90 to 96 are filled with a conductor. The magnetic sheets 82a to 82g are the core of the multi-layer transformer 80.

Further, FIGS. 6 and 7 are schematic diagrams and, therefore, strictly speaking, the number of windings of the primary windings 81a and 81c and secondary windings 81b and 81d and the positions of the through-holes 90 to 96 do not correspond in FIGS. 6 and 7.

On the primary side of the multi-layer transformer 80, the current flows in the order of the external electrode 96, through-hole 92, primary winding 81c, through-hole 91, primary winding 81a, through-hole 90, and then the external electrode 97 or in the reverse order. On the other hand, on the secondary side of the multi-layer transformer 80, the current flows in the order of the external electrode 99, the through-hole 95, the secondary winding 81d, the through-hole 94, the secondary winding 81b, the through-hole 93, and then the external electrode 98 or in the reverse order. The current flowing through the primary windings 81a and 81c produces a magnetic flux 100 (FIG. 7) in the magnetic sheets 82a to 82g. The magnetic flux 100 produces an electromotive force corresponding with the winding ratio in the secondary windings 81b and 81d. The multi-layer transformer 80 operates thus.

Here, supposing that the self-inductance of the primary windings 81a and 81c is L1, the self-inductance of the secondary windings 81b and 81d is L2, the mutual inductance of the primary windings 81a and 81c and the secondary windings 81b and 81d is M, and a magnetic coupling coefficient k is defined by the following equation:
k=|M|/√(L1·L2)(k≦1)

The magnetic coupling coefficient k is one of the indicators of the transformer function and the larger the magnetic coupling coefficient k, the smaller the leakage magnetic flux (leakage inductance) becomes and, therefore, the power conversion efficiency is high.

In the multi-layer transformer 80, because there is a magnetic body layer (magnetic sheets 82c to 82e) between the primary windings 81a and 81c and the secondary windings 81b and 81d, a leakage magnetic flux 101 (FIG. 7) is produced and, therefore, an adequate magnetic coupling coefficient k is not obtained. In order to resolve this problem, a technology (referred to as the ‘prior art’ below) that provides a dielectric layer (not shown) on the primary windings 81a and 81c and secondary windings 81b and 81d by means of screen printing or the application of paste and reduces the magnetic permeability of the magnetic body layer by means of a material that provides diffusion from the dielectric layer may be considered.

Problem to be Solved

However, the prior art is confronted by the following problems.

As a result of the diffusion of a conductive material (Ag particles, for example) from the primary windings 81a and 81c and secondary windings 81b and 81d to the conductor paste applied to the primary windings 81a and 81c and secondary windings 81b and 81d, there has been the risk of a reduction in the insulation of the primary windings 81a, primary windings 81c, secondary windings 81b and secondary windings 81d. The paste is in liquid form as a result of an organic solvent or the like, for example, and, therefore, the material is readily dispersed.

Further, even when the leakage magnetic flux is reduced by providing a dielectric layer, the gap between the primary windings 81a and 81c and secondary windings 81b and 81d widens to become ‘magnetic body layer+dielectric layer’. This means that the leakage magnetic flux readily enters the gap and, therefore, acts conversely in the direction in which the magnetic coupling coefficient k is reduced. Therefore, with the prior art, it is very difficult to increase the magnetic coupling coefficient k.

### OBJECT OF THE INVENTION

Accordingly, an object of the present invention is to provide a multi-layer magnetic part that makes it possible to increase the magnetic coupling coefficient while retaining the mutual insulation of the windings.

### DISCLOSURE OF THE INVENTION

The multi-layer magnetic part of the present invention comprises a composite sheet the center and periphery of which are a magnetic pattern and a part of which except the center and periphery is a dielectric pattern comprising a nonmagnetic body; a primary winding that is located on one face of the dielectric pattern and around the center; a secondary winding that is located on the other face of the dielectric pattern and around the center; and a pair of magnetic sheets that hold the composite sheet and primary and secondary windings from both sides and contact one another via the magnetic pattern.

Preferably, a composite sheet may be a single sheet or a plurality of stacked sheets. Further, preferably, if the primary and secondary windings face one another with the dielectric sheet of the composite sheet interposed therebetween, the primary and secondary windings may be alternately arranged on one face of the composite sheet or the primary and secondary windings may be alternately arranged on the other face of the composite sheet. Preferably, when the composite sheet is a plurality of sheets, a plurality of the primary and secondary windings can be provided with the composite sheet interposed therebetween. Here, preferably speaking, a through-hole that connects the primary and secondary windings respectively may be provided in the composite sheet. Further, here, ‘nonmagnetic body’ means a material with a smaller magnetic permeability than at least a magnetic sheet. ‘Dielectric sheet’ means a sheet with a larger resistivity than at least a magnetic sheet and is also known as a dielectric sheet or insulation sheet.

In the case of the multi-layer magnetic part of the prior art, because there is a magnetic body layer between the primary and secondary windings, a leakage magnetic flux is produced in the magnetic body layer, whereby the magnetic coupling coefficient is reduced. Therefore, in the multi-layer magnetic part of the present invention, a nonmagnetic body layer (dielectric pattern) is first provided between the primary and secondary windings. Because a core cannot be formed by this means alone, the core is formed by making the center and periphery of the composite sheet a magnetic pattern and causing the pair of magnetic sheets to contact one another via this magnetic pattern. Therefore, in the case of the multi-layer magnetic part of the present invention, a nonmagnetic body layer (dielectric pattern) is provided between the primary and secondary windings, whereby a leakage magnetic flux can be suppressed. Moreover, unlike the prior art, there is no need to form the dielectric layer by applying a dielectric paste to the primary and secondary windings and, hence, there is no deterioration of the insulation of the primary and secondary windings and no widening of the gap between the primary and secondary windings.

Further, in a preferred embodiment, the composite sheet may be inserted between the magnetic sheet and the primary or secondary winding. This composite sheet acts to increase the insulation of the primary and secondary windings.

In a preferred embodiment, a composite sheet may have a magnetic pattern and dielectric pattern of equal film thickness. In this case, the film thickness of the composite sheet is fixed irrespective of location and the pair of magnetic sheets holding the composite sheet from both sides are also flat.

The fabrication method of the multi-layer magnetic part of the present invention is a method of fabricating the multi-layer magnetic part of the present invention. First, the magnetic sheet is created by applying a magnetic body paste to a substrate and then drying the paste. A composite sheet is created by applying a nonmagnetic body paste to a substrate in the form of the dielectric pattern, applying a magnetic-body paste in the form of the magnetic pattern and then drying the pastes. Thereafter, the primary winding and secondary winding are created by applying a conductor paste to the composite sheet or magnetic sheet and drying the paste. Thereafter, the magnetic sheet and dielectric sheet thus obtained are peeled from the substrate and stacked and pressurized to form a stacked body. Finally, this stacked body is fired.

According to the present invention, a multi-layer magnetic part in which a nonmagnetic body layer is provided between the primary and secondary windings can be implemented by forming a core by providing the dielectric pattern of the composite sheet between the primary and secondary windings, rendering the center and periphery of the composite sheet a magnetic pattern, and then causing the pair of magnetic sheets to contact one another via the magnetic pattern, whereby a leakage magnetic flux can be suppressed. Moreover, unlike the prior art, there is no need to form a dielectric layer by applying dielectric paste to the primary and secondary windings and, therefore, there is no deterioration of the insulation of the primary and secondary windings and no widening of the gap between the primary and secondary windings. Therefore, the magnetic coupling coefficient can be increased while retaining the mutual insulation of the windings. Furthermore, by inserting a dielectric pattern instead of a conventional magnetic sheet, the insulation of the primary and secondary windings can also be increased.

In addition, because both the dielectric pattern and the magnetic pattern are formed in one composite sheet, in comparison with a case where the same structure is formed by stacking a dielectric sheet comprising a stacked body alone and a magnetic sheet comprising a magnetic body alone, the number of sheets can be reduced and the stacking method can be simplified.

Furthermore, the primary and secondary windings can be electrically protected by inserting a composite sheet that is the same as that described above between the magnetic sheet and the primary or secondary winding, whereby the insulation can be improved.

By providing a through-hole that connects the primary windings and secondary windings respectively in the composite sheet, the primary and secondary windings can be connected simply in comparison with a case where same are connected by means of leads or the like, whereby fabrication can be facilitated.

Because the film thicknesses of the magnetic sheet and dielectric sheet are equal, the film thickness of the composite sheet is fixed irrespective of location and, therefore, the pair of magnetic sheets holding the composite sheet from both sides can be made flat. Therefore, a wiring pattern or the like can be accurately formed on the magnetic sheet.

### BRIEF DESCRIPTION OF THE DRAWINGS

FIG. 1 is a disassembled perspective view of a first embodiment of the multi-layer transformer according to the present invention;

FIG. 2 is a vertical cross-sectional view along the line II-II in FIG. 1 after stacking;

FIG. 3 is a disassembled perspective view of a second embodiment of the multi-layer transformer according to the present invention;

FIG. 4 is a vertical cross-sectional view along the line IV-IV in FIG. 3 after stacking;

FIG. 5 is a process diagram of a fabrication method of the multi-layer transformer in FIG. 3;

FIG. 6 is a disassembled perspective view of a conventional multi-layer transformer; and

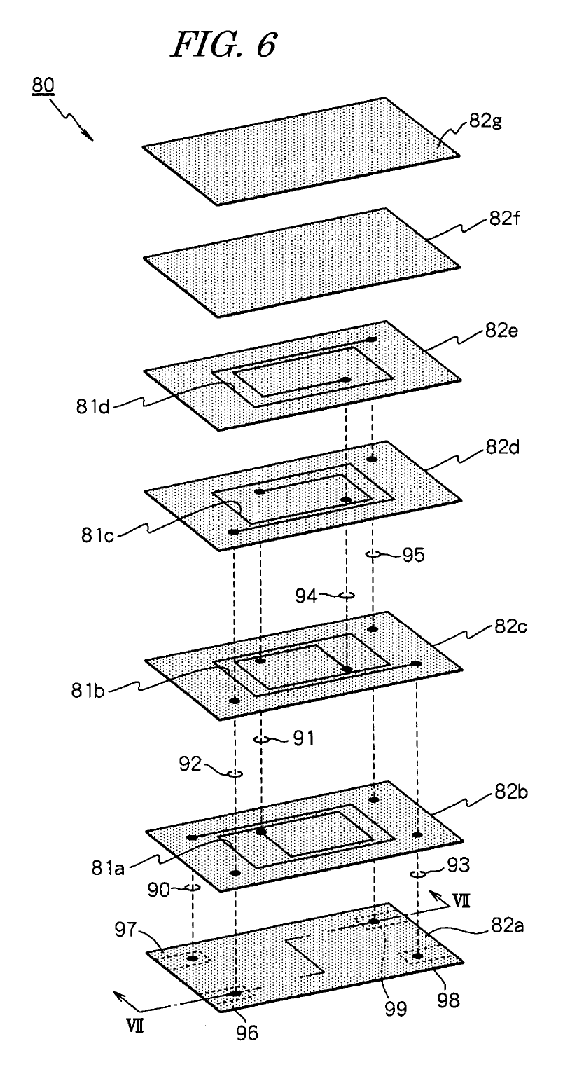

FIG. 7 is a vertical cross-sectional view along the line VII-VII in FIG. 6 after stacking.

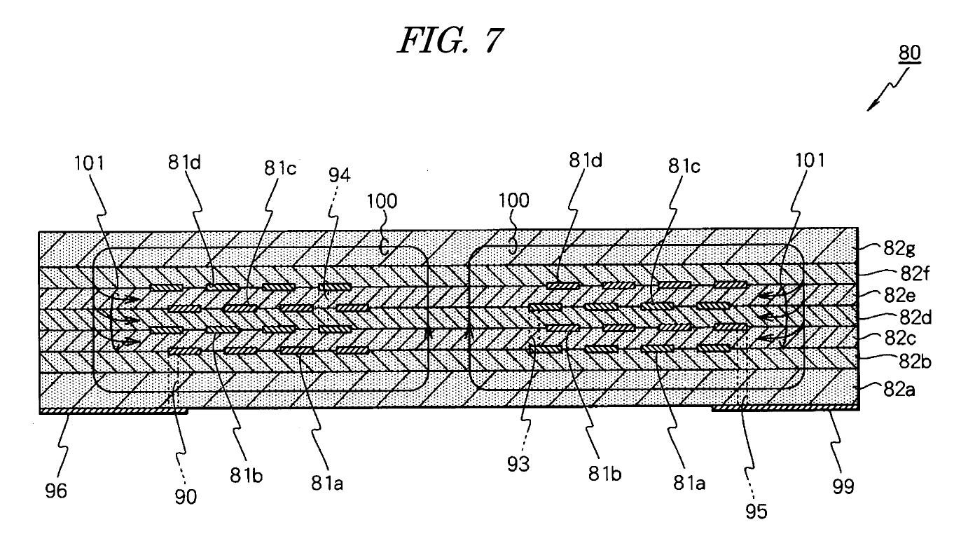

### BEST MODE FOR CARRYING OUT THE INVENTION

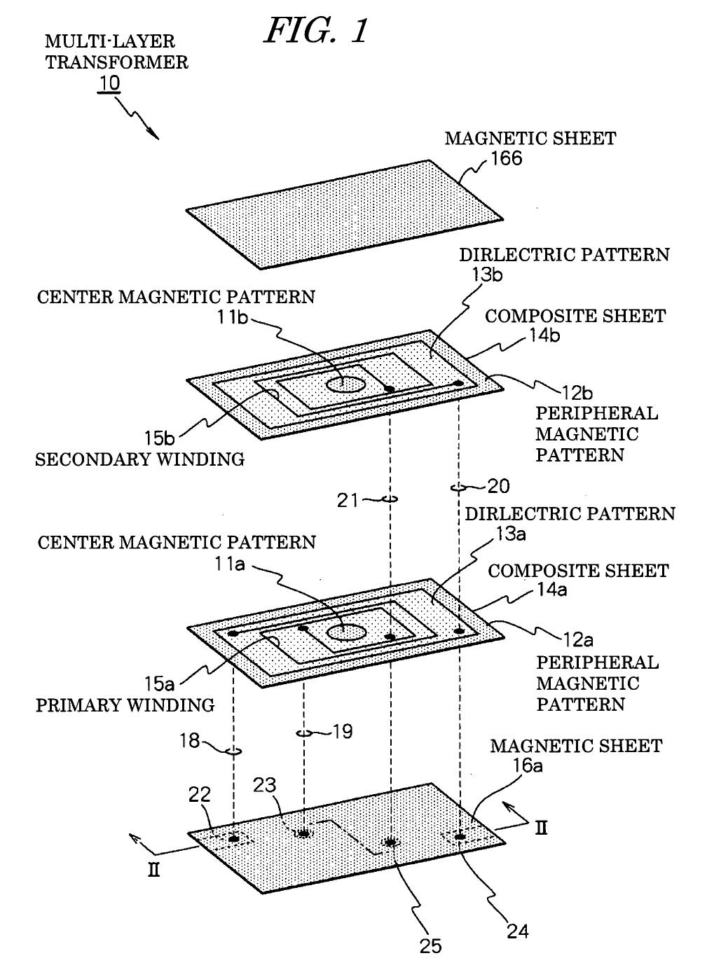

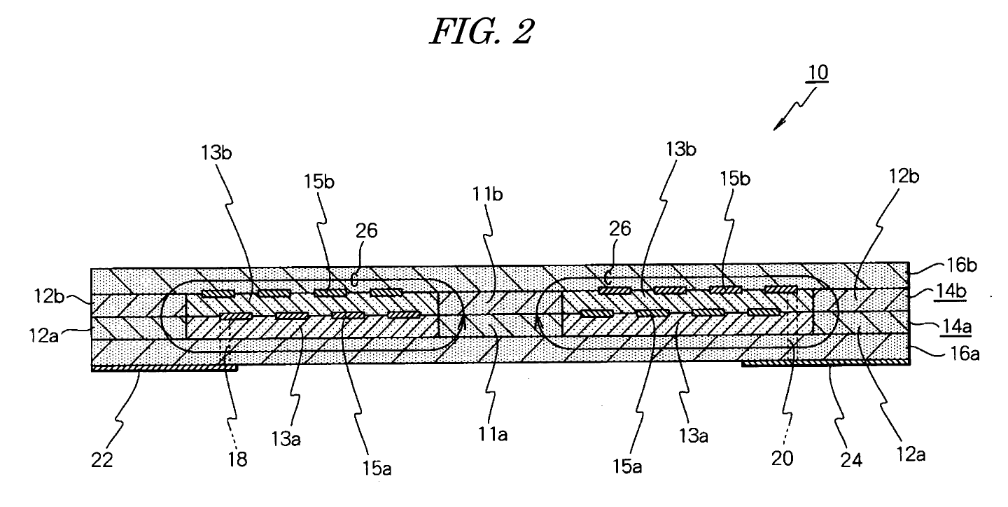

An embodiment of the multi-layer magnetic part of the present invention will be described in specific terms by taking the example of a multi-layer transformer. FIG. 1 is a disassembled perspective view of a multi-layer transformer according to a first embodiment (corresponding with claim 1) of the present invention. FIG. 2 is a vertical cross-sectional view along the line II-II in FIG. 1 after stacking. The description below is based on these figures.

A multi-layer transformer 10 of this embodiment comprises a composite sheet 14a comprising a center magnetic pattern 11a and peripheral magnetic pattern 12a that are formed at the center and periphery respectively and a dielectric pattern 13a of a nonmagnetic body that is formed in a part except the center and periphery; a composite sheet 14b comprising a center magnetic pattern 11b and peripheral magnetic pattern 12b that are formed at the center and periphery respectively, and a dielectric pattern 13b of a nonmagnetic body that is formed in a part except the center and periphery; a primary winding 15a that is located on one face of the dielectric pattern 13a and around the center; a secondary winding 15b that is located on one face of the dielectric pattern 13b and around the center; and a pair of magnetic sheets 16a and 16b that hold the composite sheets 14a and 14b, primary winding 15a and secondary winding 15b from both sides and contact one another via the center magnetic patterns 11a and 11b and peripheral magnetic patterns 12a and 12b. That is, this can be put another way by saying that the primary winding 15a is located on the other face of the dielectric pattern 13b and the secondary winding 15b is located on one face of the dielectric pattern 13b.

Further, through-holes 18 and 19 that connect the primary winding 15a and through-holes 20 and 21 that connect the secondary winding 15b are provided in the composite sheets 14a and 14b and magnetic sheet 16a. Primary-winding external electrodes 22 and 23 and secondary-winding external electrodes 24 and 25 are provided in the lower face of the magnetic sheet 16a. The through-holes 18 to 21 are filled with a conductor. The center magnetic patterns 11a and 11b, peripheral magnetic patterns 12a and 12b, and magnetic sheets 16 and 17 constitute the core of the multi-layer transformer 10.

Further, FIGS. 1 and 2 are schematic diagrams and, therefore, strictly speaking, the number of windings of the primary winding 15a and secondary winding 15b and the positions of the through-holes 18 to 21 do not correspond in FIGS. 1 and 2. Furthermore, in FIG. 2, the film thickness direction (vertical direction) is shown enlarged more than the width direction (lateral direction).

On the primary side of the multi-layer transformer 10, current flows in the order of the external electrode 22, through-hole 18, primary winding 15a, through-hole 19, and then external electrode 23, or in the reverse order. On the other hand, on the secondary side of the multi-layer transformer 10, current flows in the order of the external electrode 24, through-hole 20, secondary winding 15b, through-hole 21, and then external electrode 25, or in the reverse order. The current that flows through the primary winding 15a produces a magnetic flux 26 (FIG. 2) in the magnetic sheets 16a and 16b. The magnetic flux 26 produces an electromotive force corresponding with the winding ratio in the secondary winding 15b. The multi-layer transformer 10 operates thus.

In the multi-layer transformer 10, because there is a nonmagnetic body layer (dielectric pattern 13b) between the primary winding 15a and secondary winding 15b, a leakage magnetic flux can be suppressed. Moreover, unlike the prior art, because there is no need to form a dielectric layer by applying a dielectric paste to the primary winding 15a and secondary winding 15b, there is no deterioration of the insulation of the primary windings 15a and secondary windings 15b and no widening of the gap between the primary winding 15a and secondary winding 15b. Therefore, the magnetic coupling coefficient k can be increased while retaining the mutual insulation of the windings. Furthermore, by inserting the dielectric pattern 13b, the insulation of the primary winding 15a and secondary winding 15b also increases.

In the case of the composite sheet 14a, the film thickness of the center magnetic pattern 11a and peripheral magnetic pattern 12a and the film thickness of the dielectric pattern 13b are equal. The composite sheet 14b is also the same. As a result, the film thickness of the composite sheets 14a and 14b is the same irrespective of location and, therefore, the pair of magnetic sheets 16a and 16b that hold the composite sheets 14a and 14b from both sides are also flat.

Further, it is also possible to omit the composite sheet 14a by forming a primary winding 15a and secondary winding 15b respectively on the two faces of the composite sheet 14b. The secondary winding 15b is not on the composite sheet 14b but may be formed on the magnetic sheet 16b. A composite sheet that increases the insulation of the secondary winding 15b may be inserted between the secondary winding 15b and magnetic sheet 16b. Further, the materials and dimensions of each of the constituent elements and the overall fabrication method and so forth are pursuant to the second embodiment described subsequently.

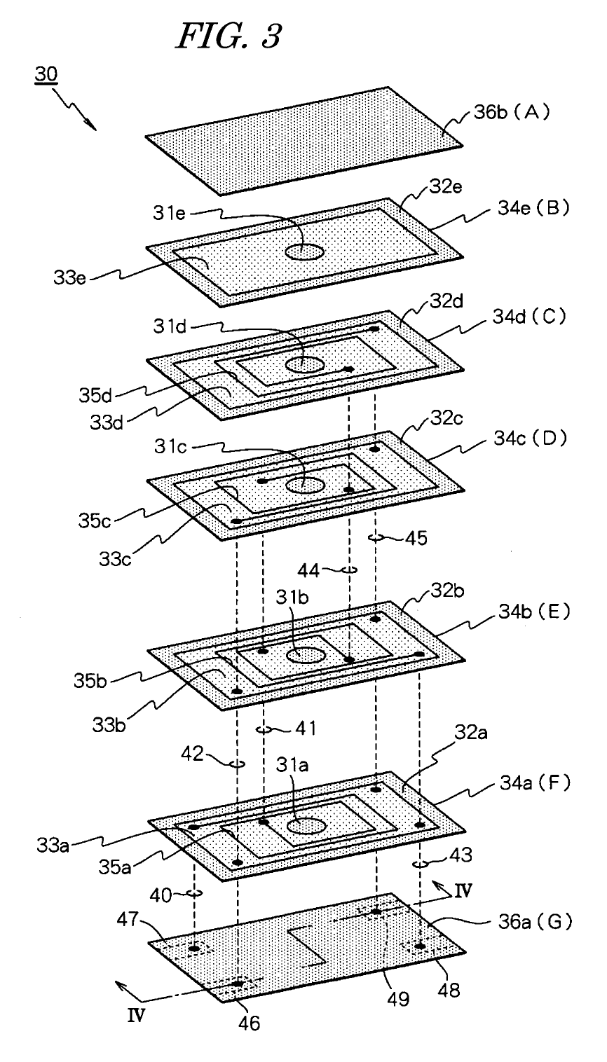

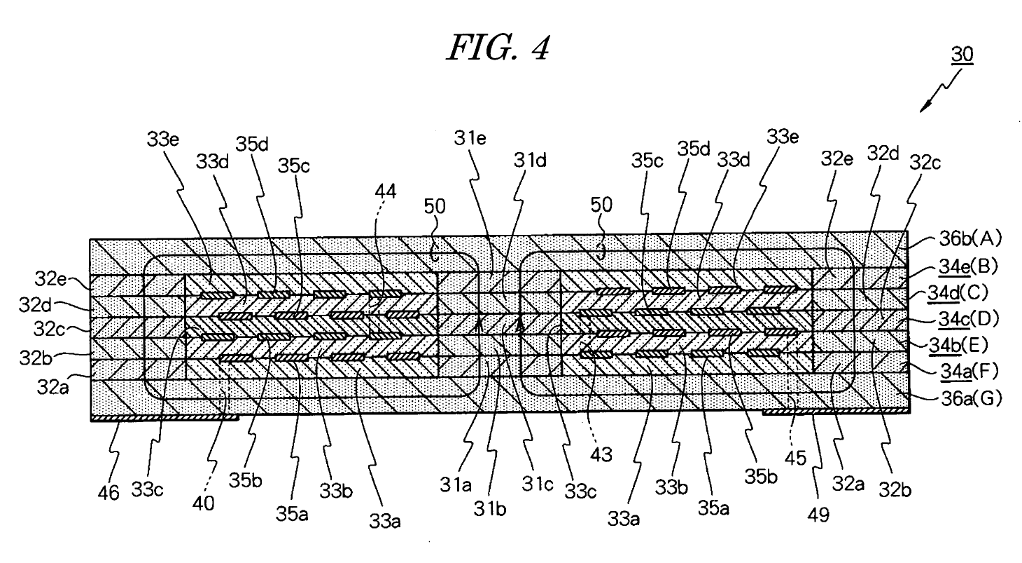

FIG. 3 is a disassembled perspective view of the second embodiment (corresponding to claims 2 to 4) of the multi-layer transformer according to the present invention. FIG. 4 is a vertical cross-sectional view along the line IV-IV in FIG. 3 after stacking. The following description is based on these figures.

The multi-layer transformer 30 of this embodiment comprises a primary-winding formation composite sheet 34a comprising a center magnetic pattern 31a and peripheral magnetic pattern 32a formed at the center and periphery thereof respectively and a dielectric pattern 33a of a nonmagnetic body formed in a part except the center and periphery; a secondary-winding formation composite sheet 34b comprising a center magnetic pattern 31b and peripheral magnetic pattern 32b formed at the center and periphery thereof respectively and a dielectric pattern 33b of a nonmagnetic body formed in a part except the center and periphery; a primary-winding formation composite sheet 34c comprising a center magnetic pattern 31c and peripheral magnetic pattern 32c formed at the center and periphery thereof respectively and a dielectric pattern 33c of a nonmagnetic body formed in a part except the center and periphery; a secondary-winding formation composite sheet 34d comprising a center magnetic pattern 31d and peripheral magnetic pattern 32d formed at the center and periphery thereof respectively and a dielectric pattern 33d of a nonmagnetic body formed in a part except the center and periphery; a secondary-winding protection composite sheet 34e comprising a center magnetic pattern 31e and peripheral magnetic pattern 32e formed at the center and periphery thereof respectively and a dielectric pattern 33e of a nonmagnetic body formed in the center other than the center and periphery; a primary winding 35a that is located on one face of the dielectric pattern 33a and around the center; a secondary winding 35b that is located on one face of the dielectric pattern 33b and around the center; a primary winding 35c that is located on one face of the dielectric pattern 33c and around the center; a secondary winding 35d that is located on one face of the dielectric pattern 33d and around the center; and a pair of magnetic sheets 36a and 36b that hold the composite sheets 34a to 34e, primary windings 35a and 35c, and secondary windings 35b and 35d from both sides and contact one another via center magnetic patterns 31a to 31e and peripheral magnetic patterns 32a to 32e.

That is, this can also be stated by saying that the primary winding 35a is located on the other face of the dielectric pattern 33b, the secondary winding 35b is located on one face of the dielectric pattern 33b, the secondary winding 35b is located on the other face of the dielectric pattern 33c, the primary winding 35c is located on one face of the dielectric pattern 33c, the primary winding 35c is located on the other face of the dielectric pattern 33d, and the secondary winding 35d is located on one face of the dielectric pattern 33d.

Through-holes 40, 41, and 42 that connect the primary windings 35a and 35c are provided in the composite sheets 34a to 34c and magnetic sheet 36a. Through-holes 43, 44, 45 that connect secondary windings 35b and 35d are provided in the composite sheets 34a to 34d and the magnetic sheet 36a. Primary-winding external electrodes 46 and 47 and secondary-winding external electrodes 48 and 49 are provided on the lower face of the magnetic sheet 36a. Through-holes 40 to 45 are filled with a conductor. Center magnetic patterns 31a to 31e, peripheral magnetic patterns 32a to 32e and magnetic sheets 36a and 36b constitute the core of the multi-layer transformer 30.

Further, because FIGS. 3 and 4 are schematic diagrams, strictly speaking, the number of windings of the primary windings 35a and 35c and secondary windings 35b and 35d and the positions of the through-holes 40 to 45 and so forth do not correspond in FIGS. 3 and 4. Further, in FIG. 4, the film thickness direction (vertical direction) is shown enlarged more than the width direction (lateral direction).

The actual dimensions of each of the constituent elements are illustrated. The magnetic sheets 36a and 36b have a film thickness of 100 μm, a width of 8 mm and a depth of 6 mm. The dielectric sheets 34a to 34e have a film thickness of 50 μm, a width of 8 mm and 6 mm deep. The primary windings 35a and 35c and secondary windings 35b and 35d have a film thickness of 15 μm, and a line width of 200 μm. A number of stacked sheets of about 10 to 50 is practical.

On the primary side of the multi-layer transformer 30, the current flows in the order of the external electrode 46, through-hole 42, primary winding 35c, through-hole 41, primary winding 35a, through-hole 40, and then the external electrode 47, or in the reverse order. On the other hand, on the secondary side of the multi-layer transformer 30, the current flows in the order of the external electrode 49, through-hole 45, secondary winding 35d, through-hole 44, secondary winding 35b, through-hole 43, and then the external electrode 48, or in the reverse order. The current that flows through the primary windings 35a and 35c produces a magnetic flux 50 (FIG. 4) in the center magnetic patterns 31a to 31e, the peripheral magnetic patterns 32a to 32e and the magnetic sheets 36a and 36b. The magnetic flux 50 produces an electromotive force corresponding with the winding ratio in the secondary windings 35b and 35d. The multi-layer transformer 30 operates thus.

In the multi-layer transformer 30, because there is a nonmagnetic body layer (dielectric patterns 33b to 33d) between the primary windings 35a and 35c and secondary windings 35b and 35d, a leakage magnetic flux can be suppressed. Moreover, unlike the prior art, there is no need to form a dielectric layer by applying a dielectric paste on the primary windings 35a and 35c and secondary windings 35b and 35d and, therefore, there is no deterioration of the insulation of the primary windings 35a, primary windings 35c, secondary windings 35b and secondary windings 35d and no widening of the gap between the primary windings 35a and 35c and secondary windings 35b and 35d. Therefore, the magnetic coupling coefficient k can be increased while retaining the mutual insulation of the windings. In addition, the insulation of the primary windings 35a and 35c and secondary windings 35b and 35d also increases as a result of the insertion of the dielectric patterns 34b to 34d.

In the case of the composite sheet 34a, the film thickness of the center magnetic pattern 31a and peripheral magnetic pattern 32a and the film thickness of the dielectric pattern 33a are equal. The composite sheets 34b to 34e are also the same. As a result, the film thickness of the composite sheets 34a and 34e is the same irrespective of location and, therefore, the pair of magnetic sheets 36a and 36b that hold the composite sheets 34a to 34e from both sides are also flat.

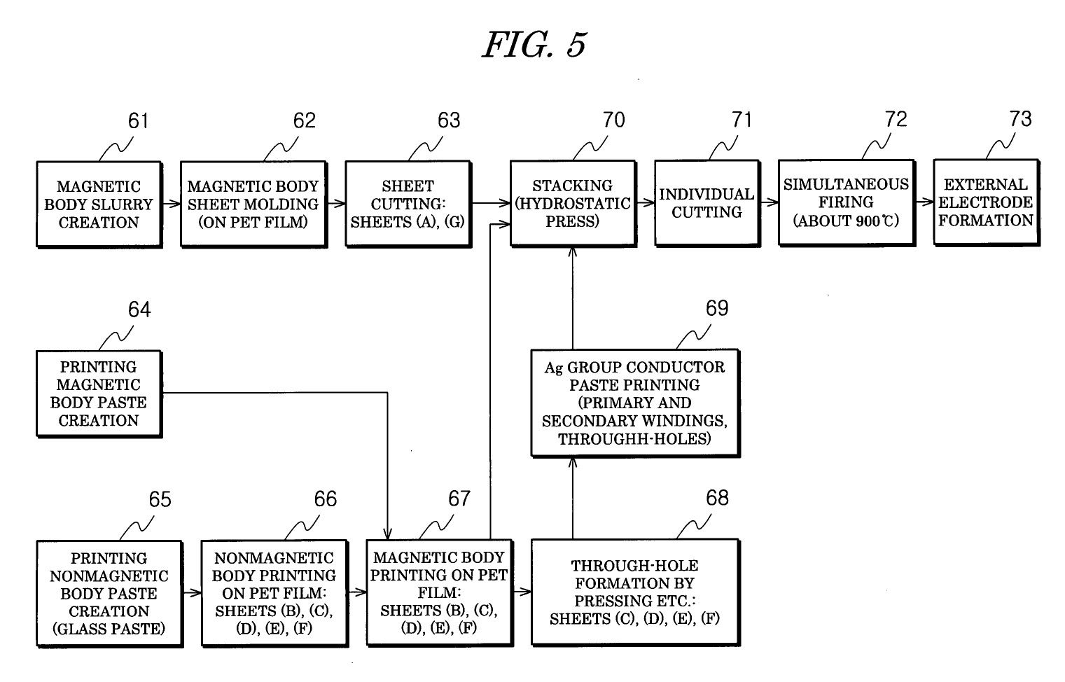

FIG. 5 shows a process diagram of a fabrication method (corresponding with claim 5) of the multi-layer transformer in FIG. 3. The following description is based on these figures.

The composite sheets (B), (C), (D), (E), and (F) in FIG. 5 correspond with composite sheets 34e, 34d, 34c, 34b, and 34a in FIG. 3. The magnetic sheets (A) and (G) in FIG. 5 correspond with magnetic sheets 36b and 36a in FIG. 3.

First, a magnetic body slurry is created (process 61). The magnetic material is a Ni—Cu—Zn group, for example. Subsequently, a magnetic sheet is molded by placing a magnetic body slurry on a PET (polyethylene terephthalate) film by using the doctor blade method (process 62). Thereafter, by cutting the magnetic sheet, the magnetic-flux formation magnetic sheets (A) and (G) are obtained (process 63).

A magnetic body paste (an Ni—Cu—Zn group, for example) is created (process 64) and a nonmagnetic body paste (glass paste, for example) is separately created (process 65). Thereafter, the dielectric patterns of the composite sheets (B), (C), (D), (E), and (F) are created by placing a nonmagnetic body paste on a PET film by using the screen-printing method (process 66). Subsequently, the magnetic patterns of the composite sheets (B), (C), (D), (E), and (F) are created by placing a magnetic body paste on a PET film by using the screen-printing method (process 67). Subsequently, through-holes are formed by means of a press or the like in the composite sheets (C), (D), (E), and (F) (process 68) and the primary and secondary windings are formed by screen-printing an Ag-group conductive paste and the through-holes are filled with a conductor (process 69).

Thereafter, the magnetic sheets (A) and (G) obtained in process 63, composite sheet (B) obtained in process 67, and composite sheets (C), (D), (E), and (F) obtained in process 69 are peeled from the PET film and stacked and made to adhere by using a hydrostatic press or the like to produce a stacked body (process 70). Subsequently, the stacked body is cut to a predetermined size (process 71). Simultaneous firing at about 900° C. is then executed (process 72). Finally, the multi-layer transformer is completed by forming an external electrode (process 73).

Further, it is understood that the present invention is not limited to the above embodiment. For example, there may be any number of composite sheets and primary and secondary windings. The shape of the primary and secondary windings is not limited to a helical shape and may be rendered by overlapping a multiplicity of letter-L shapes.

### EMBODIMENT

Here, the results of measurement of the electrical characteristics of the multi-layer transformer of the prior art and the multi-layer transformer of the present invention are shown in a comparison. The constitution of the multi-layer transformer of the prior art and of this embodiment used as this example is provided below.

(1) Transformer of the Prior Art

Primary winding: five turns/layer one layer: five turns

Secondary winding: five turns/layer two layers: ten turns

Magnetic body; use initial magnetic permeability 100

(2)-1 New Structure Multi-Layer Transformer 10

Primary winding: five turns/layer one layer: five turns

Secondary winding: five turns/layer two layers: ten turns

Magnetic body; use initial magnetic permeability 100

(2)-2 New Structure Multi-Layer Transformer 10

Primary winding: five turns/layer one layer: five turns

Secondary winding: five turns/layer two layers: ten turns

Magnetic body; use initial magnetic permeability 500

(3)-1 New Structure Multi-Layer Transformer 30

Primary winding: five turns/layer three layers: fifteen turns

Secondary winding: five turns/layer six layers: thirty turns

Magnetic body; use initial magnetic permeability 100

(3)-2 New Structure Multi-Layer Transformer 30

Primary winding: five turns/layer three layers: fifteen turns

Secondary winding: five turns/layer six layers: thirty turns

Magnetic body; use initial magnetic permeability 500

Further, the results of the electrical characteristic value of (1) to (3)-2 above are as shown in Table 1 below.

TABLE 1
Electrical Characteristic values

| STRUCTURE | Lp(μH) | Ls(μH) | Ip(μH) | Is(μH) | K |
|---|---|---|---|---|---|
| (1) | 4.25 | 8.31 | 1.48 | 3.02 | 0.807 |
| (2)-1 | 6.06 | 12.7 | 0.24 | 0.51 | 0.980 |
| (2)-2 | 28.2 | 55.1 | 0.34 | 0.72 | 0.994 |
| (3)-1 | 53.5 | 102.2 | 1.28 | 2.62 | 0.988 |
| (3)-2 | 258.1 | 515.3 | 1.03 | 2.15 | 0.998 |

*Voltage proof between primary and secondary windings is (1) 3 KV or less, (2) 8 to 10 KV, (3) 8 to 10 KV, respectively.

### INDUSTRIAL APPLICABILITY

The fabrication method of the multi-layer magnetic part of the present invention is able to create composite sheets, magnetic sheets, and primary and secondary windings by using sheet-molding technology and film thickness formation technology and makes it possible to mass-produce the multi-layer magnetic part according to the present invention accurately and inexpensively.

1. A multi-layer magnetic part, comprising:
a composite sheet obtained by applying a magnetic body paste to a substrate rendering the center and periphery thereof a magnetic pattern, and by applying a nonmagnetic body pattern to a substrate rendering a part thereof except the center and periphery a dielectric pattern comprising a nonmagnetic body;
a primary winding or secondary winding, or both such primary and secondary windings, provided on one face of the dielectric pattern and around the center;
a primary winding or secondary winding, or both such primary and secondary windings, provided on the other face of the dielectric pattern and around the center; and
a pair of magnetic sheets which are obtained by applying a magnetic body paste to a substrate and drying the paste and which hold the composite sheet and the primary and secondary windings from both sides and contact one another via the magnetic pattern.

2. The multi-layer magnetic part according to claim 1, wherein the composite sheet the center and periphery of which are a magnetic pattern and a part of which except the center and periphery is a dielectric pattern comprising a nonmagnetic body is inserted between the magnetic sheet and the primary or secondary winding.

3. The multi-layer magnetic part according to claim 1 or 2, wherein the composite sheet is stacked in a plurality of layers; and
through-holes connecting respectively a plurality of primary windings and a plurality of secondary windings located with the dielectric pattern of the composite sheets interposed therebetween are provided in the composite sheets.

4. The multi-layer magnetic part according to claim 1, 2, or 3, wherein the film thickness of the magnetic pattern and the film thickness of the dielectric pattern of the composite sheet are equal.

5. A method of fabricating the multi-layer magnetic part according to any of claims 1 to 5, comprising the steps of:
creating the magnetic sheet by applying a magnetic body paste to a substrate and drying the paste;
creating the composite sheet separately by applying a nonmagnetic body paste to a substrate in the form of the dielectric pattern and applying a magnetic body paste to the substrate in the form of the magnetic pattern and drying the pastes;
creating the primary and secondary windings by applying a conductor paste to the composite sheet or the magnetic sheet and drying the paste; and
peeling the magnetic sheet and the composite sheet thus obtained from the substrate and stacking the magnetic sheet and composite sheet and pressurizing same to produce a stacked body, and firing the stacked body.
